(19) United States
(12) Patent Application Publication
(10) Pub. No.: US 2026/0318320 A1
(43) Pub. Date: Oct. 15, 2026

(54) ROTOR FOR A FAN

(71) Applicant: ebm-papst Mulfingen GmbH & Co. KGaA & Co. KG, Mulfingen (DE)

(72) Inventors: Oliver HAAF, Kupferzell (DE); Jens Müller, Künzelsau (DE)

(21) Appl. No.: 19/644,287

(22) Filed: Apr. 10, 2026

(30) Foreign Application Priority Data
Apr. 11, 2025 (DE) 102025114476.1

(51) Int. Cl. F04D 29/32; F04D 25/06

(52) U.S. Cl. CPC F04D 29/325; F04D 25/06

(57) ABSTRACT

A fan and a rotor for a fan having a motor obstruction, wherein an electric motor of the fan extends into a flow region of a main flow of a fan impeller of the fan. At least one axial end of the rotor and/or an axial end section of the rotor is of non-rotationally symmetrical configuration.

### RELATED APPLICATIONS

The present disclosure claims priority to and the benefit of German Application 10 2025 114 476.1, filed on Apr. 11, 2025, the entire contents of which is incorporated herein by reference.

### FIELD

The present disclosure relates to a rotor for a fan having a motor obstruction, wherein an electric motor of the fan extends into a flow region of a main flow of a fan impeller of the fan.

### BACKGROUND

A large number of compact fans are known from the prior art in which the electric motor projects significantly into the impeller, thus resulting in a motor obstruction in which the motor projects into, or extends into, the flow region of the impeller of the fan. The airflow is obstructed due to this arrangement, leading to efficiency losses, turbulence, increased noise levels, and reduced overall performance of the fan.

The cause of the significantly poorer performance characteristics is flow separation at the rotor of the fan with motor obstruction. In this case, the flow can no longer follow the contour of the rotor and separates, resulting in the formation of a dead-water or recirculation region at the rotor. Due to this separation, turbulence in this region is significantly increased.

To date, the only measure known for optimizing such a fan is to reduce the motor obstruction. One known possibility for reducing the motor obstruction is to fill the recirculation region with material or to design the impeller in such a way that no recirculation region can form. However, this is not always structurally and/or aerodynamically feasible or advantageous. In this case, the impeller can only be adapted to a specific motor length. A further possibility for reducing the motor obstruction is to move the motor out of the impeller. In this case, the impeller is mounted on a second flange. Furthermore, the motor obstruction in impellers can additionally be reduced by introducing a bend in the base plate. However, this increases the axial length of the fan.

Furthermore, the efficiency of the fan can indeed be increased and noise generation reduced by modifying the rotationally symmetrical rotor geometry. Flow separation cannot, however, be completely avoided in this way, meaning that such a solution only results in a minor improvement of the fan.

### BRIEF SUMMARY

The present disclosure overcomes the aforementioned disadvantages and provides a rotor for a fan having a motor obstruction, as well as a corresponding fan, in which flow separation at the rotor and noise emission are reduced, and efficiency is optimized.

According to the present disclosure, flow separation at the rotor can be significantly improved by a non-rotationally symmetrical rotor shape. To this end, energy is imparted to the flow, preferably by means of rib-shaped bulges and/or projections, which, preferably in conjunction with constrictions and/or recesses, deflect the flow in the axial direction. In this way, flow separation at the rotor is significantly reduced. By at least partially redirecting the main flow in the axial direction or in the direction of the axis of rotation, efficiency is optimized and noise emission is reduced in comparison with a rotationally symmetrical rotor. In addition, the cooling effect of the flow is improved.

The present disclosure therefore provides a rotor for a fan, in particular a radial fan, having a motor obstruction, wherein an electric motor, in particular a rotor of the electric motor, extends into a flow region of a main flow of a fan impeller, wherein at least one axial end and/or an axial end section, preferably a rotor cup, is non-rotationally symmetrical, in particular such that the main flow can be redirected at least partially in the axial direction. As a result, a separation of the main flow at the rotor can be reduced. Furthermore, in particular the outer circumference and/or an outer shell and/or an outer peripheral surface of the rotor is of non-rotationally symmetrical configuration.

In one embodiment, one or more bulges and/or projections are formed at the axial end.

Preferably, the rotor is configured such that at least one of the bulges and/or projections extends in the radial direction of the rotor, in particular linearly and/or in curved form, preferably all bulges and/or projections extending, in particular at least in sections, from a center of the rotor or of the axial end of the rotor to a radial end of the rotor.

In one embodiment of the present disclosure, at least one of the bulges and/or projections is tapered to a point in the radial direction and/or tapers at an acute angle.

Furthermore, an embodiment is advantageous in which the plurality of bulges and/or projections are distributed in the circumferential direction of the rotor, preferably uniformly, or are arranged at a predetermined distance from one another.

In a variant, the one or more bulges and/or projections are rib-shaped and/or web-shaped.

In a further embodiment, one or more constrictions and/or recesses are formed at the axial end.

In a preferred embodiment of the present disclosure, a constriction and/or recess is formed adjacent to at least one of the bulges and/or projections, preferably immediately and/or on both sides.

In a further embodiment variant of the present disclosure, the one or more constrictions and/or recesses are concavely curved.

According to the present disclosure, a fan is further provided having a motor obstruction, wherein an electric motor of the fan extends into a flow region of a main flow of a fan impeller, with a rotor according to the foregoing disclosure. The fan impeller is arranged on the rotor, and the rotor, in particular a rotor cup of the rotor, extends into the flow region of the main flow of the fan impeller.

In particular, a motor obstruction relevant to the present disclosure is present when the following applies for a ratio of a rotor diameter of the rotor to an intake diameter of the intake opening of the fan impeller: (rotor diameter/intake diameter of the fan impeller)>0.3; and when the following applies for a ratio of a height of the rotor to a C-dimension of the fan impeller: (height of the rotor/C-dimension of the fan impeller)>0.3, in particular (rotor diameter/intake diameter of the fan impeller)>0.4 and (height of the rotor/C-dimension of the fan impeller)>0.5. In this case, the height of the rotor corresponds to an extent of the rotor in the axial direction, and the C-dimension corresponds to an extent of the fan impeller in the axial direction.

In another embodiment, the number of the one or more bulges and/or projections corresponds to and/or is equal to the number of guide vanes of the fan impeller. Alternatively, an embodiment is conceivable in which the number of bulges and/or projections is twice as large as, half as large as, three times as large as, and/or one third of the number of guide vanes of the fan impeller.

The features disclosed above may be combined in any desired manner, insofar as this is technically feasible and they are not mutually contradictory.

### BRIEF DESCRIPTION OF THE DRAWINGS

Other advantageous developments of the present disclosure are characterized in the dependent claims or are described in greater detail below together with the description of the preferred embodiment of the present disclosure with reference to the figures. The following is shown:

FIG. 1a a perspective view of a fan with a rotor;

FIG. 1b a sectional view of the fan;

FIG. 2a a plan view of the rotor;

FIG. 2b a sectional view of the rotor;

FIG. 2c a further sectional view of the rotor.

The figures are schematic by way of example. Identical reference symbols in the figures indicate identical functional and/or structural features.

### DETAILED DESCRIPTION

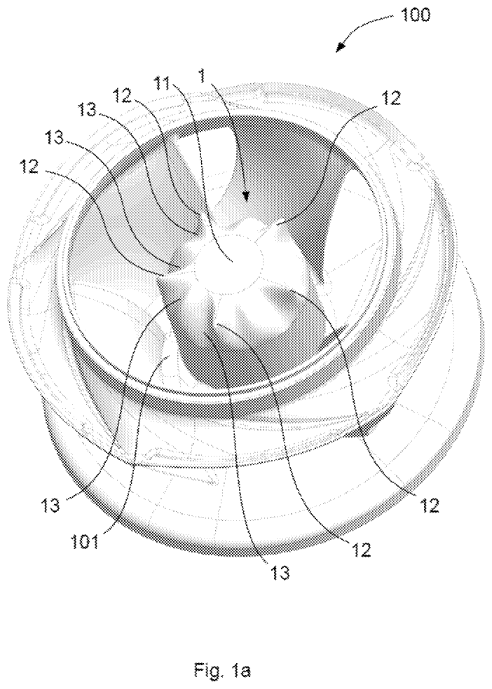

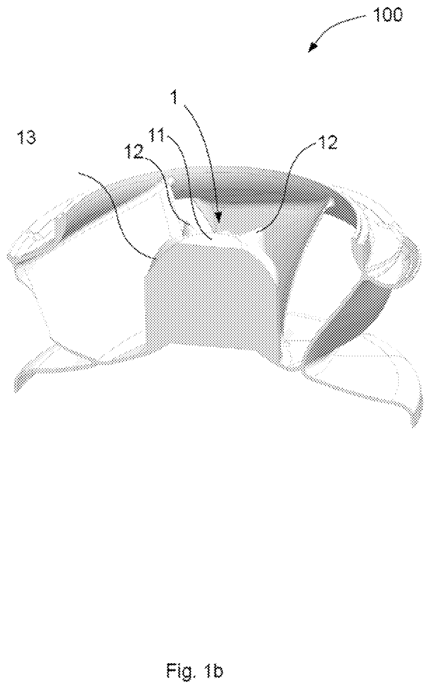

FIG. 1a shows a perspective view of a fan 100 having a motor obstruction, wherein an electric motor of the fan 100 extends into a flow region of a main flow of a fan impeller 101 of the fan 100. The fan 100 comprises a rotor 1. Furthermore, the fan impeller 101 is arranged on the rotor 1, and the rotor 1 extends into the flow region of the main flow of the fan impeller 101. At least one axial end 11 of the rotor 1 and/or an axial end section of the rotor 1 is of non-rotationally symmetrical configuration such that separation of the main flow at the rotor 1 is reducible. In particular, the outer circumference and/or an outer shell and/or an outer peripheral surface of the rotor is of non-rotationally symmetrical configuration.

Furthermore, five rib-shaped and/or web-shaped bulges and/or projections 12 are formed at the axial end 11. In this context, a number of bulges and/or projections 12 corresponds to a number of guide vanes of the fan impeller 101. The bulges and/or projections 12 extend in the radial direction of the rotor 1. The rotor 1 is further configured such that the bulges and/or projections 12 extend linearly in the radial direction of the rotor, in particular at least in sections from a center of the rotor 1 or of the axial end 11 of the rotor to a radial end of the rotor 1. Furthermore, the bulges and/or projections 12 are tapered in the radial direction and/or taper at an acute angle. Moreover, the plurality of bulges and/or projections 12 are arranged uniformly distributed in the circumferential direction of the rotor 1.

A plurality of constrictions and/or recesses 13 are also formed at the axial end 11 of the rotor, each arranged immediately adjacent on both sides to a respective bulge and/or projection 12. The constrictions and/or recesses 13 are concavely curved.

FIG. 1b shows a sectional view of the fan 100 shown in FIG. 1a with the rotor 1.

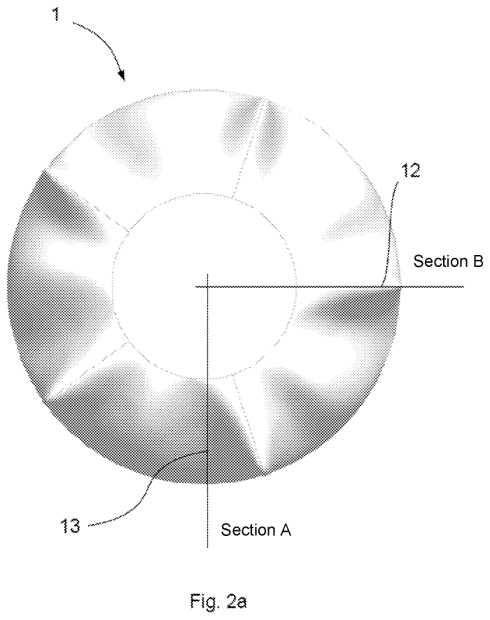

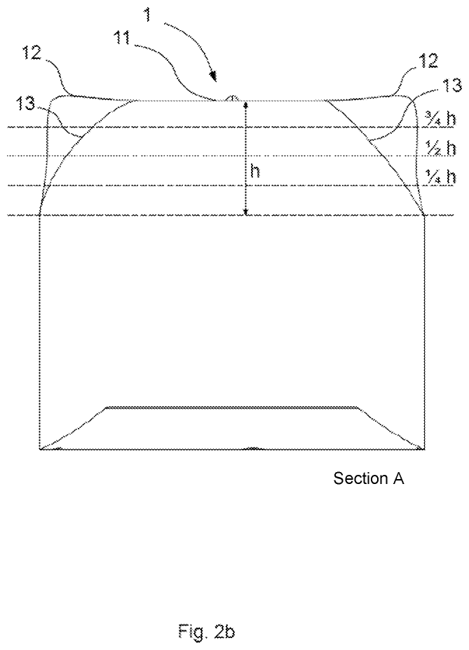

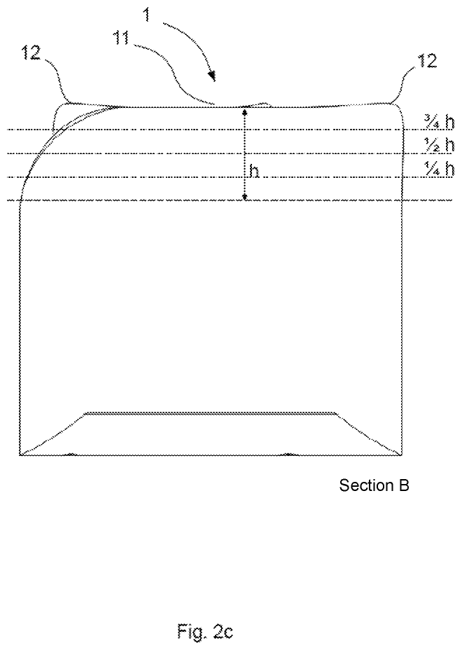

FIG. 2a shows a plan view of the rotor 1 of FIG. 1 for illustrating the sectional views shown in FIGS. 2b and 2c. FIG. 2b shows a sectional view along a Z-axis through a constriction and/or recess 13 of the rotor 1, and FIG. 2c shows a sectional view along a Z-axis through a bulge and/or projection 12. The rotor 1 has five bulges and/or projections 12, and, as shown in FIG. 2a, adjacent bulges and/or projections 12 and constrictions and/or recesses 13 are rotated relative to one another by approximately 15°.

As shown in FIG. 2b, a section through the constriction and/or recess 13 results in a region of the axial end 11 of the rotor 1 and/or of the axial end section of the rotor 1 in which the contour substantially corresponds to a straight line between a mounting receptacle of the rotor and the axial end 11 of the rotor 1. In this case, the axial end section 11 of the rotor 1 is of convex configuration.

As shown in FIG. 2c, a section through the bulge and/or projection 12 results in a region in which the contour of the rotor extends linearly along the Z-axis and bends only in the region of the mounting receptacle.

In FIGS. 2b and 2c, a heighth of the non-rotationally symmetrical axial end section 11 is shown in each case. Furthermore, in FIGS. 2b and 2c, one-quarter, one-half, and three-quarters of the height h are shown in each case.

At one-quarter height, a maximum radial extent of the axial end section 11 is 100% of the distance (rotor diameter—mounting receptacle diameter), or 100% of the rotor diameter. Preferably, the maximum radial extent of the axial end section 11 is 70-120%, more preferably 90-110%, of the distance (rotor diameter—mounting receptacle diameter). The location with the minimum radial extent of the axial end section 11 is offset by approximately 15° and is 81% of the distance (rotor diameter—mounting receptacle diameter).

At one-half height, a maximum radial extent of the axial end section 11 is 100% of the distance (rotor diameter—mounting receptacle diameter), or 100% of the rotor diameter. Preferably, the maximum radial extent of the axial end section 11 is 70-120%, more preferably 90-110%, of the distance (rotor diameter—mounting receptacle diameter). The location with the minimum radial extent of the axial end section 11 is likewise offset by approximately 15°and is 60% of the distance (rotor diameter—mounting receptacle diameter).

At three-quarters height, a maximum radial extent of the axial end section 11 is 102% of the distance (rotor diameter—mounting receptacle diameter), or 101% of the rotor diameter. Preferably, the maximum radial extent of the axial end section 11 is 70-120%, more preferably 90-110%, of the distance (rotor diameter—mounting receptacle diameter). The location with the minimum radial extent of the axial end section 11 is likewise offset by approximately 15° and is 34% of the distance (rotor diameter—mounting receptacle diameter).

Accordingly, the maximum radial extent of the axial end section 11 is 70-120%, more preferably 90-110%, of the distance (rotor diameter—mounting receptacle diameter).

FIG. 2a also shows that a constriction and/or recess 13 is formed immediately adjacent on both sides to each respective bulge and/or projection 12. A slight elevation is formed between each two corresponding constrictions and/or recesses 13.

The present disclosure is not limited in its implementation to the preferred embodiments specified above. Rather, a number of variants are conceivable which make use of the illustrated solution even in embodiments of a fundamentally different type.

1. A rotor for a fan having a motor obstruction, wherein an electric motor of the fan extends into a flow region of a main flow of a fan impeller of the fan,
wherein at least one axial end of the rotor and/or an axial end section of the rotor has a non-rotationally symmetrical configuration such that the main flow is redirectable at least partially in the axial direction,
wherein one or more bulges and/or projections are formed at the axial end, and
wherein one or more constrictions and/or recesses are formed at the axial end.

2. The rotor according to claim 1, wherein at least one of the bulges and/or projections extends in the radial direction of the rotor.

3. The rotor according to claim 2, wherein at least one of the bulges and/or projections is tapered in the radial direction and/or tapers at an acute angle.

4. The rotor according to claim 1, wherein the plurality of bulges and/or projections are arranged and distributed in the circumferential direction of the rotor.

5. The rotor according to claim 1, wherein the one or more bulges and/or projections are rib-shaped and/or web-shaped.

6. The rotor according to claim 1, wherein a constriction and/or recess is formed adjacent to at least one of the bulges and/or projections.

7. The rotor according to claim 1, wherein the one or more constrictions and/or recesses are concavely curved.

8. The rotor according to claim 1, wherein the plurality of bulges and/or projections are uniformly arranged and distributed in the circumferential direction of the rotor.

9. The rotor according to claim 1, wherein a constriction and/or recess is formed immediately adjacent to, and/or on both sides of, at least one of the bulges and/or projections.

10. A fan having a motor obstruction, wherein an electric motor of the fan extends into a flow region of a main flow of a fan impeller of the fan, comprising the rotor according to claim 1, wherein the fan impeller is arranged on the rotor and wherein the rotor extends into the flow region of the main flow of the fan impeller of the fan.

11. A fan according to claim 10, wherein a number of the one or more bulges and/or projections corresponds to a number of guide vanes of the fan impeller.
